(19) United States
(12) Patent Application Publication
(10) Pub. No.: US 2025/0070113 A1
(43) Pub. Date: Feb. 27, 2025

(54) SUSTAINABLE BATTERY ELECTRODE WITH HIGH ACTIVE MATERIAL CONTENT

(71) Applicant: Purdue Research Foundation, West Lafayette, IN (US)

(72) Inventors: Sunghwan Lee, West Lafayette, IN (US); Yuxuan Zhang, West Lafayette, IN (US)

(21) Appl. No.: 18/722,559

(22) PCT Filed: Oct. 31, 2022
(86) PCT No.: PCT/US2022/048435

§ 371 Date: Jun. 20, 2024

Related U.S. Application Data
(60) Provisional application No. 63/292,368, filed on Dec. 21, 2021.

(51) Int. Cl. H01M 4/04; H01M 4/02; H01M 4/13; H01M 4/139; H01M 4/62; H01M 10/0525

(52) U.S. Cl. CPC H01M 4/0428; H01M 4/13; H01M 4/139; H01M 4/622; H01M 4/625; H01M 10/0525; H01M 2004/021; H01M 2004/028

(57) ABSTRACT

A cathode for a lithium-based battery may include a current collector and a cathode material. The cathode material may include an inactive material comprising a carbon conductor and vapor-phase oxidative chemical vapor deposited (oCVD) polymer binder, and an active material uniformly coated and conductively coupled together with the oCVD polymer.

### CROSS REFERENCE TO RELATED APPLICATIONS

This application claims the benefit of U.S. Provisional Application No. 63/292,368 filed Dec. 21, 2021, the entirety of which is incorporated by reference.

### TECHNICAL FIELD

This disclosure relates to lithium-ion battery and, in particular, to electrodes for lithium ion batteries.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of an optimized low inactive material content electrode.

FIG. 2 illustrates a comparison of an optimized cathode and an unoptimized cathode.

FIG. 3 illustrates a manufacturing technique for the optimized cathodes.

FIG. 4A-B illustrates a vapor-phase synthetic process of an Ni-rich cathode accordingly to various experiments and a graph of the electrical conductivity of pristine and modified samples.

FIG. 5A-B illustrates the long cycle performance and coulombic efficiency of pristine and modified samples and a rate performance of pristine and modified samples according to various experimentation.

FIG. 6A-B illustrate nyquist impedance plots of the pristine and the modified sample before and after 200 cycles.

FIG. 7A-B illustrates a 3D visualization of various secondary-ion fragments distributed in the cathode electrolyte interphases (CEIs) of pristine NCM811 (upper) and Modified sample (lower) along with a Schematic of the CEI in pristine NCM811 and Modified sample.

FIG. 8A-B illustrates the effect of water adsorption on the performance compared between batteries integrating a pristine cathode and an oCVD PEDOT coated cathode.

FIG. 9A-B illustrates a comparison of discharge-charge profiles of the Li—S batteries at 0.1 C rate and fast-charging performance of Li—S coin cell with different cathodes.

FIG. 10 illustrates long-term cycling stability of different cathodes at 0.5 C.

FIG. 11 illustrates cycling performance of Li—S pouch cell with different cathodes (the digital photograph of Li—S pouch cell as shown in the inset).

FIG. 12 illustrates an example of a lithium ion battery having an anode and an optimized cathode accordingly to the various embodiments described herein.

### DETAILED DESCRIPTION

To provide sufficient electronic conductivity for the electrode and adhesivity among active materials, conductive additives and binders are inevitable to be used in electrodes, which may take 10-15 wt % of the total weight of the electrode. While the conductive additives and binders are unable to furnish any capacity during the charge and discharge process, which were called inactive materials. For increasing the specific energy of the battery, reducing the content of the inactive materials is considered as a simple and effective way. Directly decreasing the inactive materials such as conductive additives may lead to the lack of electronic conductivity and resistance augment of the electrode. The fewer binder materials may trigger the loss of active materials and cause the decline of the battery capacity. Hence, exploring a way to enhance the specific energy with high stability of lithium ion battery. The binders and conductive additives with less amount is a promising method to reduce inactive materials and increase the specific energy for a battery. Besides, the active materials themselves usually experience the degradation caused by the continuous growth of electrode-electrolyte interphases during the circulation, as thus the modification for active materials is required. However, general coating materials (solid-state) are hard to achieve high coverage for complete protection. Thus, the state of the coating materials has to be changed to realize the conformal coating.

Accordingly, an optimized cathode, a lithium ion battery with an optimized cathode, and method of making the same are provided. By way of introductory example, a cathode for a lithium-ion battery comprising features active materials uniformly coated and conductively coupled together with the conjugated polymer, such as poly(3,4-ethylenedioxythiophene) (PEDOT) applied with vapor-phase oxidative chemical vapor deposition (oCVD). The active materials may account for at least 99 wt % of the battery cathode material while the inactive materials, which include the PEDOT and a carbon conductor, are less than or equal to 1 wt % of the cathode material.

The oCVD polymer coating layer, which exhibits the high electronic conductivity, mechanical flexibility, and conformality (or step-coverage), provides a multi-functional electrode coating layer for battery electrodes resulting in a high active material content (99 wt % or higher). In addition, the oCVD applied polymer provide various technical advantages applicable to battery cathode design beyond the minimization of inactive materials. For example, an oCVD polymer provides protection for electrode active materials for avoiding the unfavorable parasite reactions with the electrolyte. In addition, a mechanically flexible oCVD polymer can accommodate the volume variation during the charge and discharge process. The coated polymer between electrolyte and electrode exhibits excellent integrity and ensures sustainability of active materials after long circulation with extended service life. Additional technical advantages are described and made evident in the various examples provided herein.

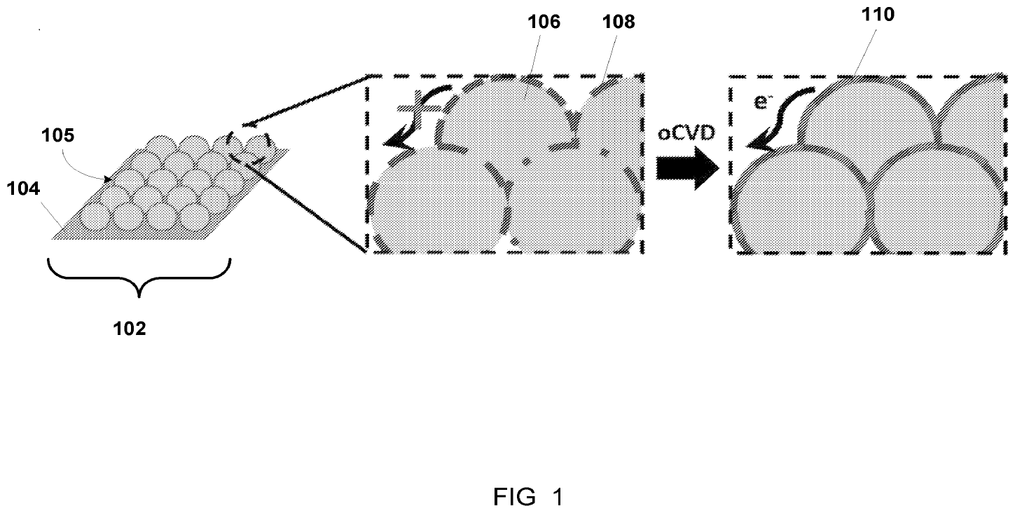

FIG. 1 illustrates an example of an optimized low inactive material content electrode 102. The optimized electrode 102 may include a current collector 104 and a cathode material 105. The cathode material 105 may include active materials 106 and inactive materials 108.

The term active materials, as defined herein, are materials which provide charge and discharge capacity for a battery. Active materials participate in the battery redox chemical reactions to produce electrical energy when the cell discharges. The material returns to its original state during the charge process. Examples of active materials may include, but are not limited to, LiCoO₂, LiFePO₄, LiNi_{1-x-y}CoₓMn_{y}O₂, LiNi_{1-x-y}CoₓAl_{y}O₂, LiMn₂O₄, and bulk sulfur or sulfur-carbon composites.

The inactive materials may include materials which provide electronic conductivity and adhesivity for the electrode but are inactive for battery capacity. Examples of inactive materials include, but are not limited to, Super-P conductive carbon black, carbon nanotube, acetylene black, Polyvinylidene fluoride conductor, Polymerized Styrene Butadiene Rubber.

As described herein, a coating may be used to bind the active materials together. The coating may a conjugated polymer, such as poly(3,4-ethylenedioxythiophene) (PEDOT), polypyrrole (PPy), polyaniline (PANI). The conjugated polymer coating is fabricated using vapor-phase oxidative chemical vapor deposition (oCVD). oCVD application of conjugated polymers conformally coats the substrate geometry. Moreover, the mild thermal environment (<200° C.) for oCVD allows the deposition of conjugated polymers onto any substrate. Another benefit of oCVD is that it can be configured with roll-to-roll reactor in the actual production process. By way of oCVD, the polymer may conformally coat the particles of the active material to form a conductive network in which the particles are joined together at junctions where the outer surfaces of the coated particles touch.

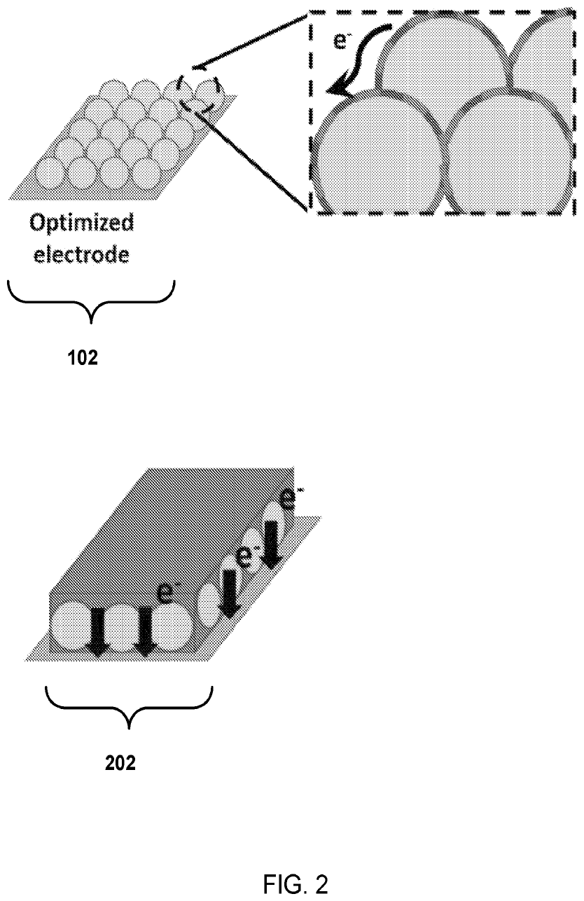

As described herein, the term “oCVD polymer” is used to describe the conformally coated copolymer coating made possible by oCVD. Referring to FIG. 2, an oCVD polymer 110 is coated conformally along with the gaps between the primary particles and the surface of the secondary particles. Structurally speaking, a conformal polymer coating means the polymer covers the surface of an active particle and joins adjacent active particles at junctions where the coated surfaces of the particles intersect.

FIG. 2 illustrates a comparison of an optimized cathode (102) and an unoptimized cathode (202). In the unoptimized cathode, which is representative of a traditional cathode, the gaps between the particles and between the particle/current collector are filled with inactive material. The in many unoptimized cathodes, inactive material may account for 10-15 wt % of the total weight of the electrode. In addition, general coating materials (solid-state) are hard to achieve high coverage for complete protection.

In the optimized cathode 102, the gaps and space between the particles and/or the particles and current collector are completely filled with the inactive material. Thus, the cathode with oCVD polymers, as described herein, has substantially less inactive materials over traditional approaches. In various experiments, the amount of the binder, used for binding active materials, was successfully reduced without any negative effects on the electrochemical performance of the batteries in various experimentation.

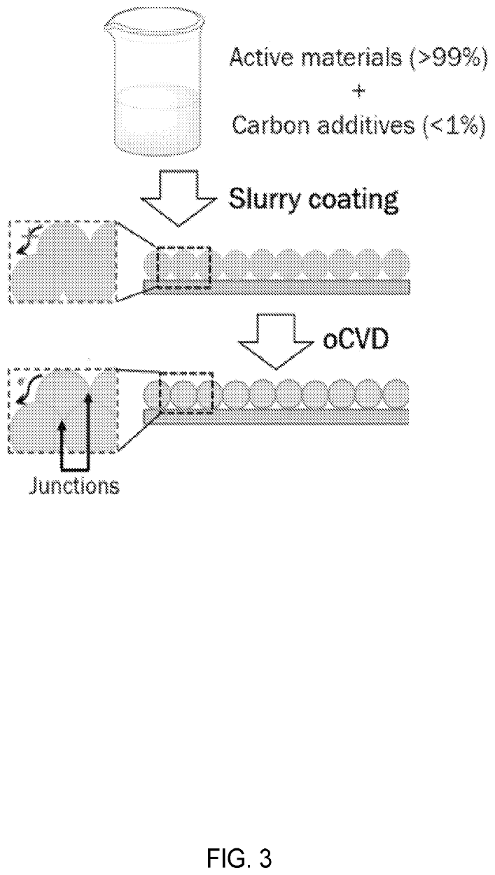

FIG. 3 illustrates a manufacturing technique for the optimized cathodes. According to the embodiments described herein, a multi-functional oCVD polymer coating is a key step in the manufacturing of the cathode and functions as a protection layer. The oCVD technique realize ultrahigh active material concentration (>99 wt %) in the battery and, consequently, ultralow inactive material concentration (<1 wt %).

By way of example, active materials and conductive additives (carbon nanotubes, less than 1 wt % in weight ratio) in organic solvent (n-methyl-2-pyrrolidone) may be mixed evenly into slurry. In various experiments, the conditions were a stirring rate of 500 rpm, stirring time of 6 h, and the temperature of 25° C. The slurry may be uniformly coated on a current collector (i.e.: Al or Cu foils) by blade-casting. The thickness should be controlled between 8-10 μm. The electrode may then be dried in a vacuum furnace at 80° C. for 40 mins.

The semi-assembled electrode may be transferred into an oCVD chamber. The conjugated polymers may be deposited with 50 nm thickness on the electrode to finish the electrode manufacturing. In this step, deposited conjugated polymers may be expected to generate conductive networks with carbon nanotubes for the high-efficiency transmission of electrons. Contributed to the high-efficiency conductive networks, the conductive additives are reduced to a great extent. Besides, the oCVD conjugated polymer generated junctions between active materials to glue them together, which means the function of binders is integrated into the oCVD conjugated polymer. Thus, binders are not requisite like traditional electrodes. Owing to the reasonable decreasing of the inactive materials (i.e.: conductive additives and binders), the weight ratio of active material is achieved as high as >99 wt %, leading to higher battery capacity and enhanced stability.

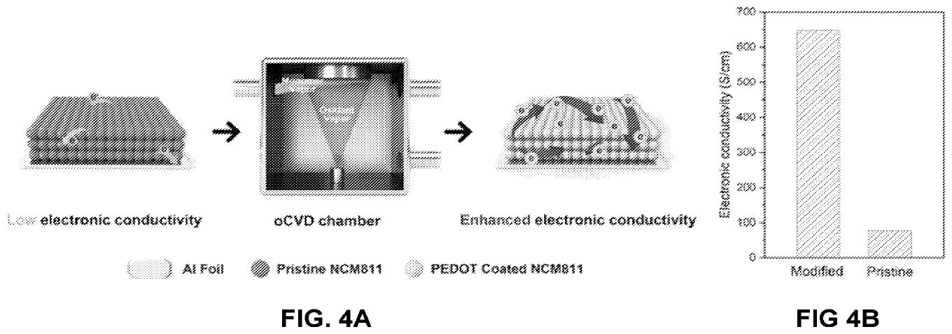

FIG. 4 illustrates a vapor-phase synthetic process of an Ni-rich cathode modified with highly conformal oCVD PEDOT accordingly to various experiments. Due to the high electronic conductivity and conformality of the oCVD processed polymer, the highly effective and electronically conductive networks between the conjugated polymer and carbon additives were constructed.

FIG. 4B is a graph of the electrical conductivity of pristine and modified samples. A technical advantage provided by the oCVD PEDOT is the amount of carbon additives can be largely reduced. The obtained electrode showed enhanced electronic conductivity compared with the sample without conjugated polymer. The experiments noted here demonstrate that the inactive materials' content can be largely reduced to 1 wt % (typically 10-15 wt %, enhanced more than 10 times) and the highly active materials' content (99 wt %) is achieved.

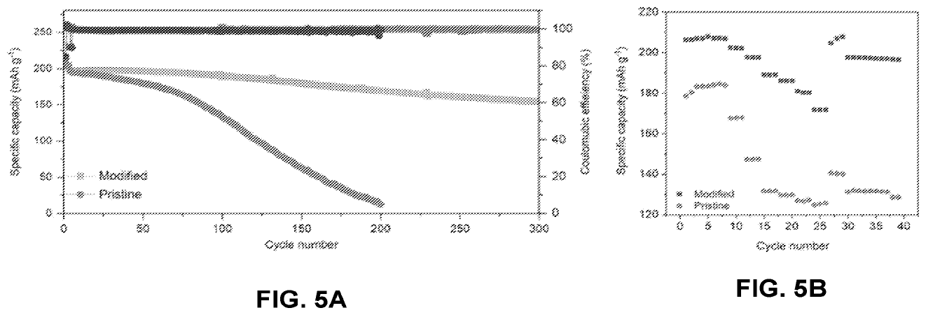

FIG. 5A illustrates the long cycle performance and coulombic efficiency of pristine and modified samples. The mechanical flexibility of the oCVD polymer prevents delamination of the coating layer due to the inevitable volume variation of active materials during the charge-discharge process, which has been a challenging issue in inorganic coating layer application. The oCVD conjugated polymer coated on electrode particles extends the service life of batteries.

FIG. 5B illustrates rate performance of pristine and modified samples according to various experimentation. Conductivity and flexibility of the oCVD conjugated polymer realized the high rate performance and excellent reversibility of lithiation and de-lithiation.

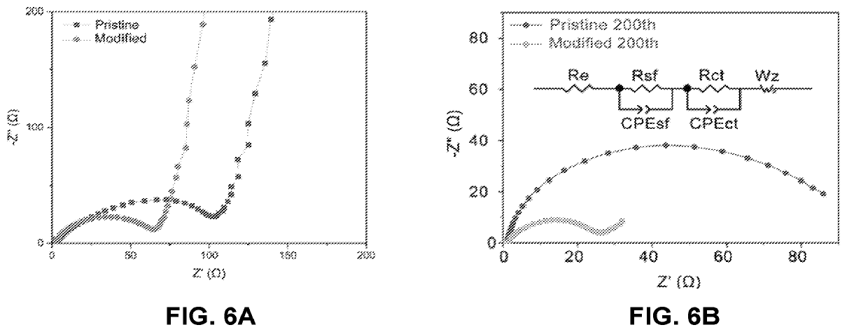

FIG. 6A-B illustrate nyquist impedance plots of the pristine and the modified sample before (FIG. 5A) and after 200 cycles (FIG. 5B). An increase in overall battery resistance of the pristine sample (i.e., without polymer coating) is much significant, compared to that of the coated sample. The increased resistance was caused by the accumulation of the continuous unfavorable layer products due to parasitic reactions during battery circulation. However, the undesirable accumulation of layer products is effectively restricted by the oCVD-coated layer.

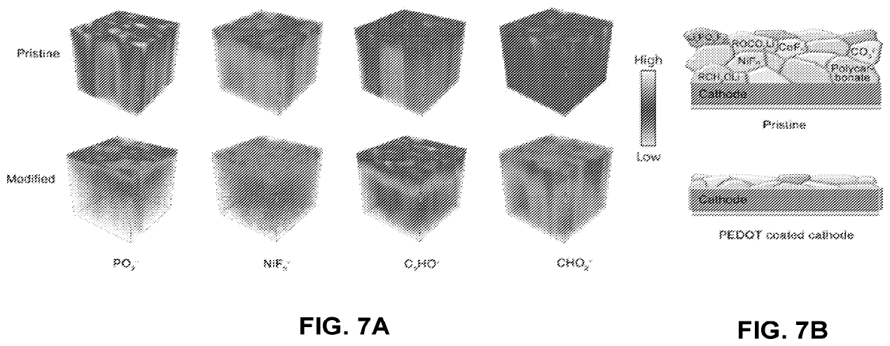

FIG. 7A illustrates a 3D visualization of various secondary-ion fragments distributed in the cathode electrolyte interphases (CEIs) of pristine NCM811 (upper) and Modified sample (lower). FIG. 7B illustrates a Schematic of the CEI in pristine NCM811 and Modified sample. The ToF-SIMS investigations indicate that the modified sample has thinner and lighter CEIs. With the oCVD conjugated polymer, the formation of a CEI layer can be effectively limited.

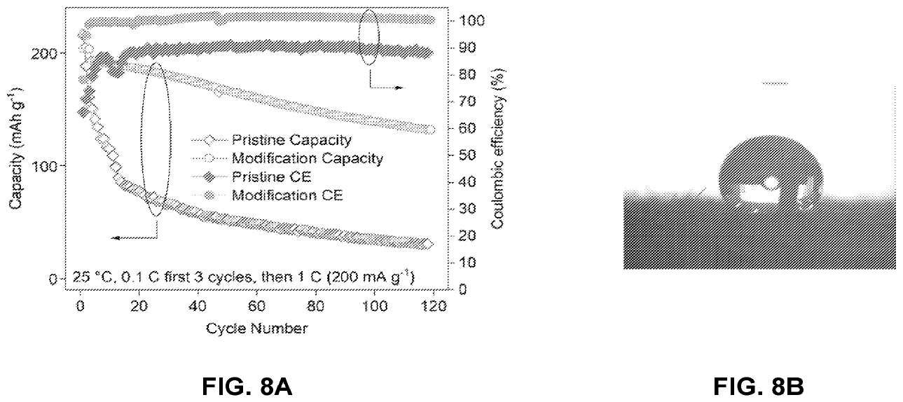

FIG. 8A illustrates the effect of water adsorption on the performance compared between batteries integrating a pristine cathode and an oCVD PEDOT coated cathode. The greater performance of oCVD PEDOT-coated cathode is due to the limited water adsorption on the cathode surface since the pristine cathode and the oCVD PEDOT coated cathode were exposed to the water before battery assemblies for 20 days; then fully dried to avoid water adsorption to anode and electrolyte; and finally integrated to the batteries. Therefore, the performance difference is attributed to the initial water exposure conditions. Unlike the pristine cathode, the cathode performance protected by oCVD PEDOT is evidenced to be well protected/preserved.

FIG. 8B illustrates the hydrophobicity of oCVD PEDOT and the same water repellent characteristics leads to the battery performance enhancement in FIG. 8A. It should be noted that other approaches to PEDOT coating, such as solution-processed PEDOT:PSS, are hydrophilic, which does not work as a water repellent coating layer.

In addition to the optimization of Ni-rich cathodes, oCVD PEDOT was employed to optimize the electrochemical performance of the Li—S battery. Sulfur cathodes that were made with sulfur and carbon additives are denoted as P1. Sulfur cathodes made with sulfur, carbon additives, and binder (polyvinylidene fluoride) are denoted as P2. Cathodes that were manufactured through oCVD technique without binder are denoted as PE (sulfur and carbon additives with oCVD polymer).

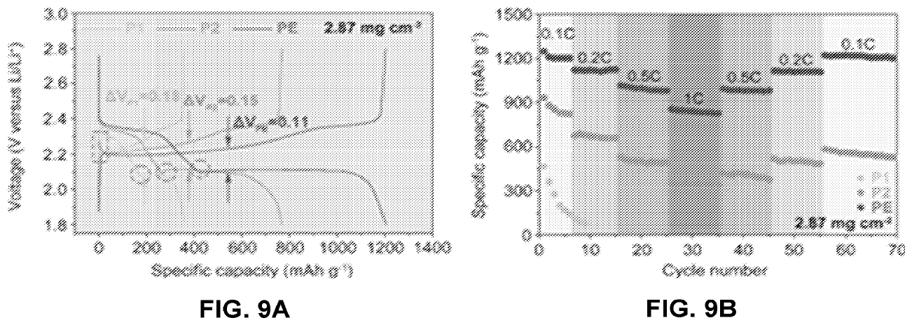

FIG. 9A illustrates a comparison of discharge-charge profiles of the Li—S batteries with different cathodes at 0.1 C rate. FIG. 9B illustrates fast-charging performance of Li—S coin cell with P1, P2, and PE cathodes.

The 5th charge/discharge profiles of cells with different cathodes (i.e.: P1, P2 and PE) at 0.1 C are plotted in FIG. 9A. The cell with the PE cathode exhibits a lower overpotential (ΔV_{PE}<ΔV_{P2}<ΔV_{P1}) and delivers a capacity of 1205 mAh/g at 0.1 C, considerably higher than those of the cells with P1 cathode (359 mAh/g) or P2 cathode (767 mAh/g). Besides, In the charge profiles of the cell with P1 and P2 cathode, a distinct potential barrier occurred at the beginning of the charging process as marked in the red rectangle, which demonstrates the presence of insulted Li₂S₂ and Li₂S generated on the surface of the electrode and huge polarization. Furthermore, the rate performance of the Li—S batteries with the different cathodes depends on the cathodes' kinetic features during the electrochemical process in FIG. 9B. Among the control samples, the P1 cathode exhibits the poorest rate performance. The P2 cathode demonstrates a mediocre rate capability which is better than the cathode without polymer binder (i.e.: the P1 cathode). However, the PE cathode delivers the corresponding discharge capacities of 1205.3, 1120.2, 1005.9, 850.7 mAh/g at 0.1 C, 0.2 C, 0.5 C, and 1 C, respectively.

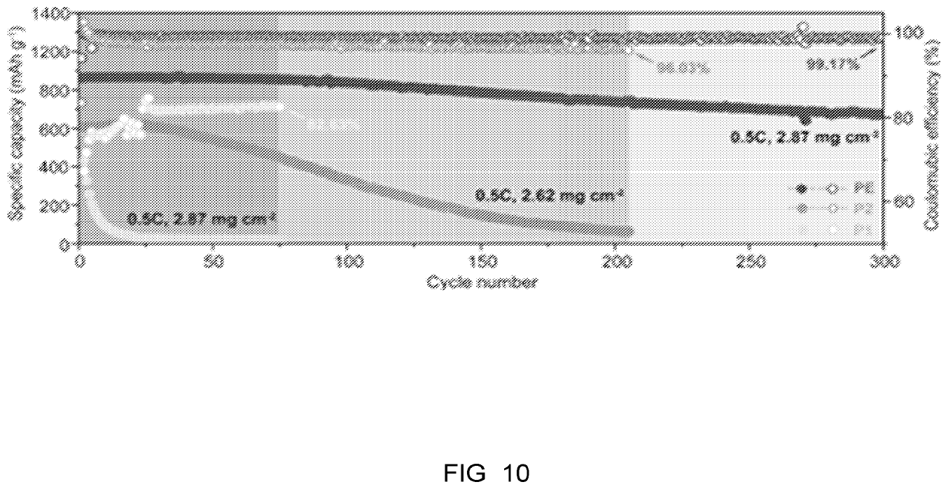

FIG. 10 illustrates long-term cycling stability of different cathodes at 0.5 C. The long-term cycling stability of various cathodes in coin cells at 0.5 C is shown in FIG. 10. The PE cathode offers the best cycling performance with an initial capacity of 866.1 mAh/g and 677.8 mAh/g after 300 cycles, exhibiting a slow capacity attenuation (0.072% per cycle). The P2 cathode delivers only 607.4 mAh/g during the first discharge and decays below 50 mAh/g after 204 cycles. The P1 cathode demonstrates sharper fading from the beginning due to the absence of the polymer binder, which initiates the loss of the active material (sulfur) during the charge/discharge process. Notably, the coulombic efficiency for the cathode is higher than 98%.

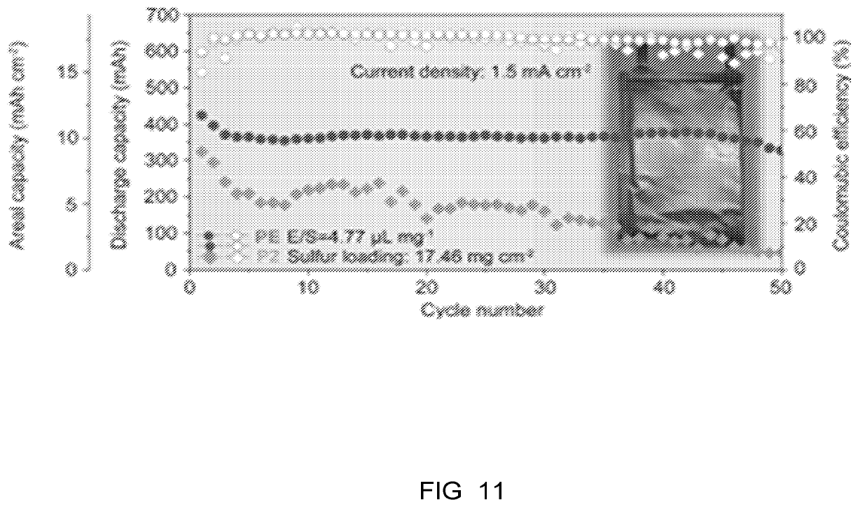

FIG. 11 illustrates cycling performance of Li—S pouch cell with different cathodes (the digital photograph of Li—S pouch cell as shown in the inset). Pouch cells with the PE cathode and the P2 cathode are assembled to simulate the practical application as indicated in FIG. 11. The pouch cell with the PE cathode delivers an initial capacity of 424.3 mAh (corresponds to 675 mAh/g) at 1.5 mA/cm² with high sulfur loading of 17.46 mg/cm² and a lean electrolyte condition (4.77 μL/mg). In contrast, the cell with the P2 cathode delivers only 324.7 mAh (corresponds to 545 mAh/g) and a lower coulombic efficiency of 85.1% compared to the 93.8% of PE cathode cell. Moreover, there is still a discharge capacity of 328.5 mAh (corresponds to 523 mAh/g) after 50 cycles, which is much higher than the cell with the P2 cathode (47.2 mAh, corresponds to 75 mAh/g).

This result further shows the oCVD PEDOT is able to enhance the electrochemical performance of the sulfur cathode and enable great potential in the practical application of high-energy-density Li—S batteries.

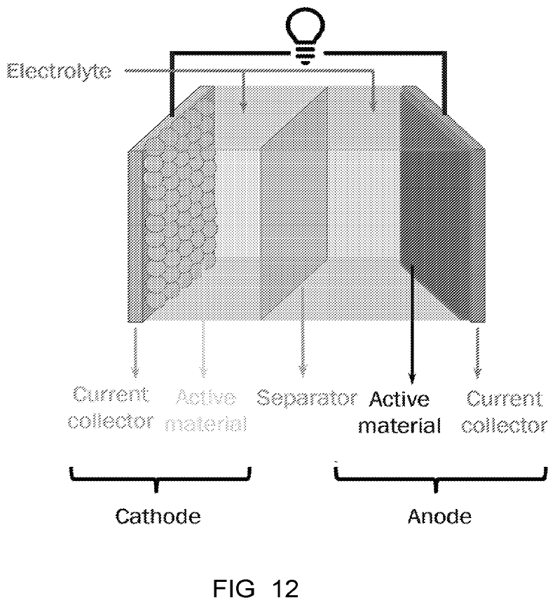

FIG. 12 illustrates an example of a lithium-based battery having an anode and an optimized cathode accordingly to the various embodiments described herein. Battery may further include an anode and a separator positioned between the cathode and anode. The battery may further include an electrolyte between the cathode and anode. In some examples, the battery illustrated in FIG. 12 may be a battery pouch, or other form-factors of lithium-based batteries.

The cathode and/or battery may be implemented with additional, different, or fewer components than illustrated. Each component may include additional, different, or fewer components.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations. The appendix attached herewith includes additional embodiments, experimental validation, and examples and is incorporated by reference herein.

What is claimed is:

1. A cathode for a lithium-based battery comprising:
a current collector and a cathode material, the cathode material comprising:
inactive material comprising a carbon conductor and vapor-phase oxidative chemical vapor deposited (oCVD) polymer binder; and
active material uniformly coated and conductively coupled together with the oCVD polymer.

2. The cathode of claim 1, wherein the active material account for at least 99 wt % of the cathode material while the inactive material is less than or equal to 1 wt % of the cathode material.

3. The cathode of claim 1, wherein the polymer is poly(3,4-ethylenedioxythiophene) (PEDOT).

4. The cathode of claim 1, wherein the polymer conformally coats the particles of the active material to form a conductive network in which the particles are joined together at junctions where the outer surfaces of the coated particles touch.

5. The cathode of claim 4, wherein polymer is configured to flex to accommodate expansion and contraction of the conductive network.

6. The cathode of claim 1, wherein conductive network is hydrophobic, which prevents the cathode surface from water adsorption, detrimental to the crystal structure of the cathode materials.

7. The cathode of claim 1, wherein the active material comprises LiCoO₂, LiFePO₄, LiNi_{1-x-y}CoₓMn_{y}O₂, LiNi_{1-x-y}CoₓAl_{y}O₂, LiMn₂O₄, bulk sulfur, sulfur-carbon composites, or a combination thereof.

8. A method of manufacturing a battery cathode comprising:
providing an active material for a battery cathode;
depositing, using Oxidative Chemical Vapor Deposition (oCVD), a conductive oCVD polymer onto the active material to hold the active particles together; and
forming, in response to the depositing, a conductive network on a current collector, the conductive network comprising particles coated in the polymer and joined together at junctions where the outer surfaces of the coated particles touch.

9. The method of claim 8, wherein at least 99 wt % of the conductive network is from the active material.

10. The method of claim 8, wherein the polymer is poly(3,4-ethylenedioxythiophene) (PEDOT).

11. A lithium-based battery comprising:
an anode;
an electrolyte; and
a cathode, the cathode comprising a cathode material having active particles uniformly coated and conformally coupled together with conductive oCVD polymer.

12. The lithium-ion battery of claim 11, wherein the polymer is poly(3,4-ethylenedioxythiophene) (PEDOT).

13. The cathode of claim 11, wherein the polymer conformally coats the particles of the active material to form a conductive network in which the particles are joined together at junctions where the outer surfaces of the coated particles touch.

14. The lithium-ion battery of claim 8 wherein the cathode is hydrophobic.

15. The lithium-ion battery of claim 8 wherein the polymer flexes between the active particles to accommodate volume variation during charge and discharge of the battery.

16. The cathode of claim 8, wherein the active particles account for at least 99 wt % of the cathode material.
